(19) United States
(12) Patent Application Publication
(10) Pub. No.: US 2025/0358395 A1
(43) Pub. Date: Nov. 20, 2025

(54) GENERATING 3D IMAGES AND VIDEOS FROM 2D IMAGES AND VIDEOS

(71) Applicant: GOOGLE LLC, Mountain View, CA (US)

(72) Inventors: Asier Rios Molina, San Jose, CA (US); Abhishek Kar, Fremont, CA (US); Ashish Singh, Mountain View, CA (US); Zhonghua Xi, Fremont, CA (US); Florian Pierre Guy Dubost, San Jose, CA (US); Goutam Bhat, Zurich (CH); Dominik Philemon Kaeser, New York, NY (US); Federico Tombari, Zug (CH); Adarsh Prakash Murthy Kowdle, San Francisco, CA (US); Prune Solange Garance Truong, Zurich (CH); Diego Martin Arroyo, Zurich (CH); Jihee Hwang, New York City, NY (US); David Joseph New Tan, Zurich (CH); Aveek Purohit, Palo Alto, CA (US)

(21) Appl. No.: 19/208,055

(22) Filed: May 14, 2025

Related U.S. Application Data
(60) Provisional application No. 63/647,825, filed on May 15, 2024.

(51) Int. Cl. H04N 13/139; G06T 5/77; G06T 7/285

(52) U.S. Cl. CPC H04N 13/139; G06T 5/77; G06T 7/285; G06T 2207/20084

(57) ABSTRACT

Techniques are directed to generating a 3D image of an object in a scene from a 2D image of the object in the scene that involves generating a reprojected image having a mask defined by a representation of the object. The mask may include a set of pixels and, in some implementations, the set of pixels coincides with an edge of the representation of the object. The inpainting is performed using a model that is trained to fill in gaps within such masks and as such the inpainting does not require the 2D image be separated into background and foreground layers.

### CROSS-REFERENCE TO RELATED APPLICATION

This application claims priority to U.S. Provisional Application No. 63/647,825, filed on May 15, 2024, and U.S. Provisional Application No. 63/789,240, filed Apr. 15, 2025, the disclosures of which are incorporated by reference herein in their entireties.

### BACKGROUND

Three-dimensional (3D) images can be viewed in devices such as head-mounted displays for extended reality (XR), virtual reality (VR), and augmented reality (AR). 3D images can also be viewed on stereoscopic (e.g., lenticular) displays in telepresence videoconferencing applications, for example.

### SUMMARY

Implementations described herein relate to generation of stereoscopic (three-dimensional, or 3D) images from monoscopic (two-dimensional or 2D) images. As used herein, images can refer to a single image and a sequence of image frames (video). 3D imagery is accomplished using the stereo effect; that is, generating left and right images from a single image. To generate a 3D image of an object from a 2D image for viewing on a client device, such as an XR device or a lenticular display, the client device sends the 2D image to a server configured to generate the 3D image from the 2D image. The 2D image can be, for example, a left image. The server generates a depth image from the 2D image, forms a reprojected image based on the 2D image and the depth image, and generates the right image by inpainting the reprojected image. In some implementations, the depth image is generated using a pair of models: a relative model configured to generate a full-resolution or downsized relative depth image that includes values between 0 and 1 indicating a relative distance from a camera, and a metric model configured to generate a downsized metric depth image that includes actual distances from the camera; the server generates the depth image by combining the full-resolution relative depth image and the downsized metric depth image. In some implementations, the server performs additional post-processing on the depth image that aligns the pixels of the depth image with contours of the object in the 2D image. In some implementations, the server generates the reprojected image by mapping pixels of the 2D image to a new set of pixels based on the depth image. The mapping of the pixels can result in a mask including pixels having no content (“disoccluded regions”) that is defined by the object. The inpainting of the reprojected image involves, in some implementations, inputting the reprojected image into a U-net convolutional model that is trained to perform inpainting based on input images having custom masks and inpainted output images. The client device may then use the resulting left image and right image to form the 3D image for a user. In some implementations in which the 2D image is one of multiple image frames, the server generates a temporally consistent depth frame at a time t+1 by inputting the 2D image and the depth frame at time t and possibly previous times into the pair of models by which the depth frame at time t+1 is computed. In some implementations, the server generates a temporally consistent inpainted frame at time t by computing optical flows between the reprojected frame at time t and reprojected frames at a set of previous times.

In one general aspect, a method can include receiving a first image of an object, the first image having a plurality of pixels representing the object and including a first pixel. The method can also include generating a depth image from the first image, the depth image including a depth value for a pixel corresponding to the first pixel. The method can further include generating a reprojected image by moving at least content of the first pixel to a second pixel of the first image, the second pixel being based on the depth value, wherein the moving produces a mask for the object. The method can further include generating a second image by inpainting the mask, the first image and the second image together providing a three-dimensional representation of the object to a user.

In another general aspect, a computer program product comprising a nontransitory storage medium, the computer program product including code that, when executed by a processor, causes the processor to perform a method. The method can include receiving a first image of an object, the first image having a plurality of pixels representing the object and including a first pixel. The method can also include generating a depth image from the first image, the depth image including a depth value for a pixel corresponding to the first pixel. The method can further include generating a reprojected image by moving at least content of the first pixel to a second pixel of the first image, the second pixel being based on the depth value, wherein the moving produces a mask for the object. The method can further include generating a second image by inpainting the mask, the first image and the second image together providing a three-dimensional representation of the object to a user.

In another general aspect, an apparatus can include memory and a processor coupled to the memory. The processor can be configured to receive a first image of an object, the first image having a plurality of pixels representing the object and including a first pixel. The processor can also be configured to generate a depth image from the first image, the depth image including a depth value for a pixel corresponding to the first pixel. The processor can further be configured to generate a reprojected image by moving at least content of the first pixel to a second pixel of the first image, the second pixel being based on the depth value, wherein the moving produces a mask for the object. The processor can further be configured to generate a second image by inpainting the mask, the first image and the second image together providing a three-dimensional representation of the object to a user.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram illustrating an example viewing of a 3D image of an object in a client device, according to an aspect.

FIG. 1B is a diagram illustrating an example client device and example server device configured to generate a right image from a left image, according to an aspect.

FIG. 1C is a diagram illustrating an example client device and example server device configured to generate a sequence of right frames from a sequence of left frames, according to an aspect

FIG. 2A is a diagram illustrating an example model configured to generate a depth image including a first model and a second model, according to an aspect.

FIG. 2B is a diagram illustrating an example relative model configured to generate a relative inverse depth at full resolution.

FIG. 2C is a diagram illustrating an example metric model configured to generate a metric inverse depth at reduced resolution.

FIG. 3A is a diagram illustrating an example model configured to generate temporally consistent frames in the case of a sequence of multiple frames.

FIG. 3B is a diagram illustrating an example model configured to generate temporally consistent frames in the case of a sequence of multiple frames.

FIG. 4A is a diagram illustrating an example model configured to generate an inpainted right image, according to an aspect.

FIG. 4B is a diagram illustrating an example diffusion model that is part of the inpainting model.

FIG. 4C is a diagram illustrating an example subblock of the diffusion model.

FIG. 5 is a diagram illustrating an example model for generating a temporally consistent inpainting of reprojected frames in the case of a sequence of multiple frames.

FIG. 6 is a diagram illustrating an example electronic environment in which the above-described generation of a right image from a left image may be performed, according to an aspect.

FIG. 7 is a flow chart illustrating an example process of generating a right image from a left image for forming a three-dimensional image, according to an aspect.

### DETAILED DESCRIPTION

Extended reality (XR), virtual reality (VR), and augmented reality (AR) devices are capable of presenting three-dimensional (3D) images to a user. Such 3D images may be generated using special equipment and workflows. For example, 3D images may be generated using a system involving multiple cameras positioned with respect to one another such that the resulting imagery simulates a 3D experience for the user. Such special equipment and workflows can be expensive and a barrier to creating three-dimensional content. For example, the multiple cameras must be carefully calibrated to produce the desired effect, and recalibration may be necessary after sufficient time or usage.

It is possible, however, to generate 3D content from existing 2D images without using such expensive special equipment and workflows. For example, many people have libraries of 2D images that may be viewed on many types of electronic devices (e.g., tablets, smartphones), including XR and VR devices. It is noted that a 3D image may be generated stereoscopically from a pair of almost identical 2D images: a left image and a right image. The left and right images have the same content but are slightly displaced from one another. Viewed together in a binocular system, the left image and the right image produce a 3D effect for a user and therefore the left image and right image are said to form a 3D image.

A fundamental issue with generating a 3D image from a 2D image in a library is that, even if the 2D image can be considered a left image, a corresponding right image is not readily available. Given a left image, an algorithm is sought that is configured to generate a right image and to combine the left image and right image to produce a 3D image for the user.

An existing algorithm for generating a 3D image from a 2D left image may be described as follows. First, the algorithm generates a depth image that includes a set of pixels corresponding to pixels of the left image such that the set of pixels have depth values representing distance from a camera capturing the left image. The depth value can be represented by a range of values (e.g., between zero and one, between one and 100, etc.) It is noted that an object in an image can be defined as being represented by a set of pixels in the depth image having about the same depth values. In some implementations, the depth image has the same amount of pixels as the 2D left image, so that each pixel of the depth image corresponds to a pixel of the 2D left image and occupies the same position in the depth image as the corresponding pixel of the 2D left image. In some implementations, the depth image has a different amount of pixels as the 2D left image, so that there exists a mapping between each pixel of the depth image and each pixel of the 2D left image. Then the algorithm generates a reprojected image by moving the content of a first pixel, or a first set of pixels, of the left image to the location of a second pixel, or second set of pixels. The first pixel/first set of pixels, represents the object. The second pixel/second set of pixels is identified based on a depth value of a depth image corresponding to the first pixel/first set of pixels. Put another way, moving can include the content of (value of) a first pixel may being used to overwrite the content of (value) of the second pixel and identifying the first pixel as lacking content. This can mean setting the value of the first pixel to a default value (e.g., zeros, null, high values, etc.). For example, in some implementations, a distance of a location of the second pixel from a location of the first pixel may be inversely proportional to the depth value of the pixel of the depth image corresponding to the first pixel. In some implementations, content includes grayscale values of the set of pixels. In some implementations, content includes weights corresponding to red, green, and blue subpixels. In some implementations, other characteristics of the set of pixels other than content, e.g., pixel location, may be moved. A reprojected image is accordingly a version of the original image (e.g., the left image) with pixels defining a representation of an object moved to a different location based on the depth image. This reprojected image in theory would provide the displacement needed to produce the stereoscopic effect for a 3D image.

Nevertheless, moving the pixel content to generate the reprojected image results in some pixels having gaps, or in other words pixels having no content (default values). For example, in a conventional algorithm, the left image may be split into a background portion and a foreground portions, such that the left image has pixels assigned to a background portion and pixels assigned to a foreground portion. The set of pixels representing the object are located in the foreground portion. The moving of pixel values in the foreground portion can result in such gaps. The gaps are inpainted such that the gaps are filled in with content from the background portion. Moreover, in the conventional algorithm, the inpainting of the background portion is further based on the depth image. Upon inpainting, e.g., filling in the gaps in the pixels of the reprojected image, the right image is generated and a 3D image is provided to the user via the stereoscopic effect,

A technical problem with the above-described conventional algorithm for generating a right image from a left image is that the algorithm is cumbersome and is not configured to convert 2D video to 3D video. For example, the splitting of a 2D image into a background layer and a foreground layer is computationally complex and can cause difficulties in generating 3D video from a 2D video. Moreover, 3D video generating using conventional techniques may have a significant amount of flicker, which can cause a viewer of the 3D video discomfort. Flicker is caused by inconsistent behavior of the 3D image frames in time. Such inconsistent behavior of the 3D image frames can be caused by the model used to generate the depth images for each 2D image. For example, conventional models lack an expectation that the depth frames will have continuity over time for the sequence of 2D images frames as a whole because the depth frames are derived independently for each frame. Accordingly, when the in paintings of the foreground of a sequence of 2D images is based on a corresponding sequence of depth images (e.g., the inpainting of each 2D image is based on a corresponding depth image as stated above), the inpainted image frames will have that inconsistent behavior which causes flicker and hence user discomfort.

Disclosed implementations provide a technical solution to the problem of generating a 3D image of an object in a scene from a 2D image of the object in the scene that involves generating a reprojected image having a mask defined by a representation of the object. The mask includes a set of pixels that lack content due to moving pixel content. In some implementations, the set of pixels coincides with a representation of the edge of the object. The representation of the edge of the object is a boundary curve (band, outline) in the image that defines the boundary of the image of the object. The mask is generated by the reprojection of a first set of pixels of the 2D image to a second set of pixels. The set of pixels of the mask may accordingly be pixels from the first set of pixels that lack content (e.g., have default values) after the reprojection. That is, the mask is a disoccluded region of pixels coincident with an edge of the representation of the object. The inpainting of the mask is performed using a model that is trained to fill in the disoccluded regions, e.g., the pixels having no content, and as such the inpainting does not require the 2D image be separated into background and foreground layers.

In some implementations, a depth image is generated using a pair of models: a relative model configured to generate an inverse relative depth image, and a metric model configured to generate a downsized inverse metric depth image. Thus, the inverse depth image can be a first depth image reflecting a function (e.g., the inverse function) of (a function applied to the image (e.g., the left 2D image). The inverse metric depth image can be a second depth image reflecting a function (e.g., an inverse function) applied to the image. The server generates the depth image by combining the inverse relative depth image and the downsized inverse metric depth image. In some implementations, there is additional postprocessing performed on the depth image that aligns the pixels of the depth image with contours of the object in the 2D image.

In some implementations in which the 2D image is one of multiple image frames at a time t, a temporally consistent depth frame is generated at a time t+1 by inputting the 2D image and the depth frame at least at time t and, in some implementations, at previous times t−1, t−2, etc., into the pair of models by which the depth frame at time t+1 is computed. Specifically, each of the pair of models has an encoder and a decoder and the encoder at time t can provide input into both the decoder at time t (and in some implementations at previous times t−1, t−2, etc.) and the decoder at time t+1. Moreover, the depth frame generated at time t (and in some implementations at t−1, t−2, etc.) may be input into the decoder at time t+1. That is, temporal consistency refers to a dependence of the depth frames on previous depth frames.

In some implementations, generating temporal consistency in the depth frames includes computing an optical flow based on image frames at times t and t+1 and depth frames at times t and t+1. An optical flow represents an apparent motion of pixels between image frames. The optical flow is used to predict a warped image frame at time t+1 due to the image frame at time t. The warped image frame is a result of an application of the optical flow applied to each pixel of the image frame, or in other words, an image in which the apparent motion of pixels is applied. Blending weights for the image frame at time t+1 and warped frame at time t+1 are then generated based on flow magnitude, confidence, and color difference, and a smoothed depth frame at time t+1 is generated.

In some implementations, performing temporally consistent inpainting involves computing optical flows between a reprojected frame at time t and each of a set of previous reprojected frames. For example, the optical flows may be computed for previous frames at times t−1, t−2, and t−3, although frames further back in time may also be used. The optical flows are respectively used to generate a set of warped reprojected frames at, e.g., times t−1, t−2, and t−3. The set of warped reprojected frames and the inpainted frame at time t are combined, e.g., averaged at the time t within the mask, to produce an averaged frame. The averaged frame is combined with the mask and the reprojected frame at time t to form a temporally consistent inpainted frame at time t.

A technical advantage of the above-described technical solution is that, unlike the conventional algorithm for generating 3D images from 2D images, the technical solution is well-adapted to provide a 3D video from a 2D video. For example, a 3D video generated according to the technical solution will have reduced flicker, thus making the viewing of the 3D video a better experience for a user.

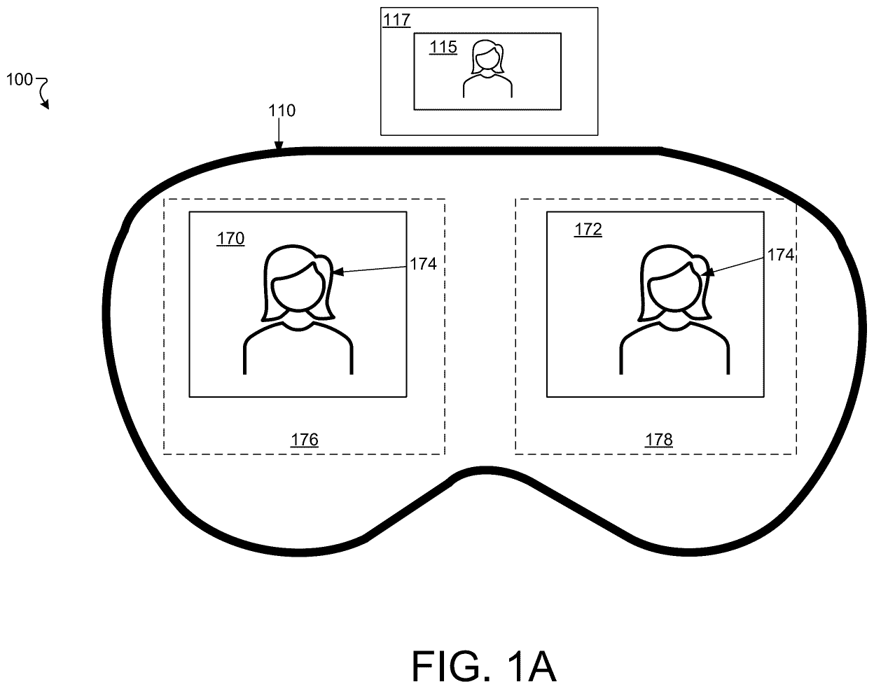

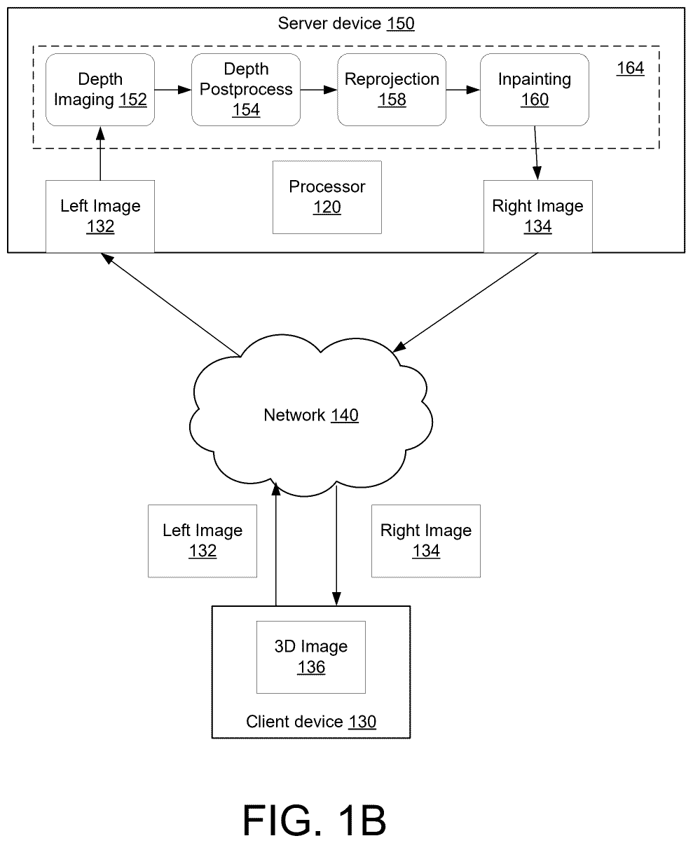

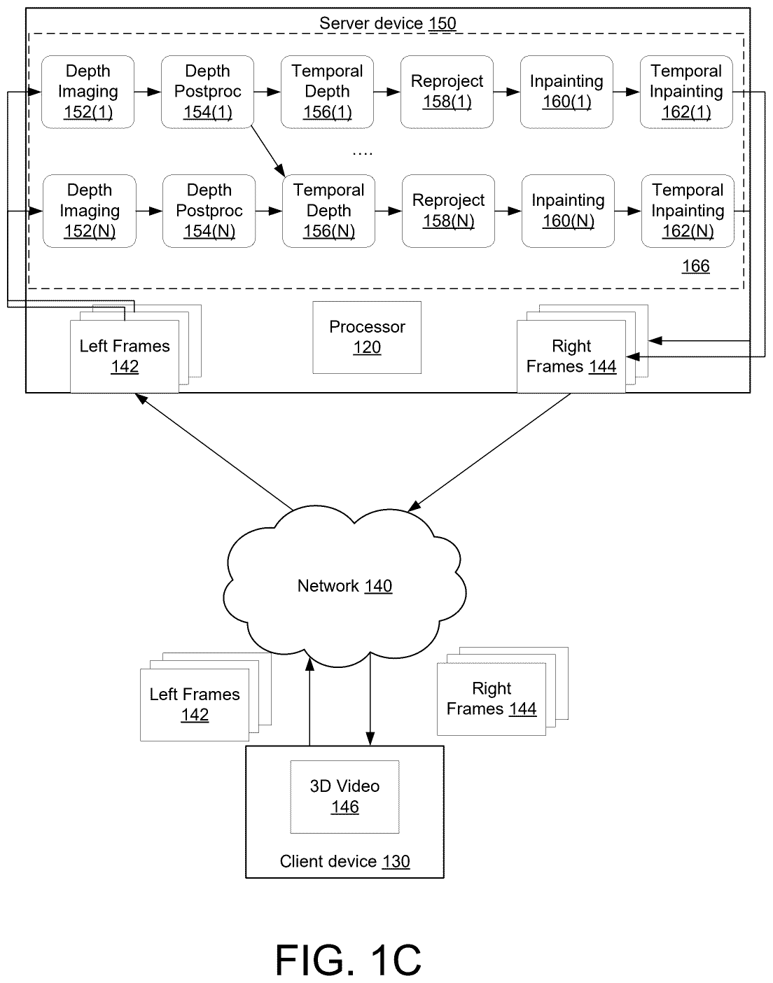

FIG. 1A is a diagram illustrating an example environment 100 in which a viewing of a 3D image made from a left image 170 of an object 174 and right image 172 of the object 174 in a client device 110 takes place. As shown in FIG. 1A, the client device 110 is a head-mounted display for an extended reality (XR) system, e.g., XR goggles. The viewing of the images 170 and 172 in the environment 100 is shown from the user's perspective.

The client device 110 is configured to display left image 170 on a left display 176 and right image 172 on a right display 178. The object 174 in the right image 172 is in a slightly different position within the right image 172 than the object 174 is in the left image 170. The user accordingly forms a 3D image via the stereoscopic effect from both left image 170 and right image 172. In some implementations, the left display 176 and the right display 178 are aligned so that the stereoscopic effect produces the 3D image to the user as expected. In some implementations, pixels of the left image 170 and right image 172 have three values corresponding to red, green, and blue weights for a color image. In some implementations, pixels of the left image 170 and right image 172 have one value corresponding to a grayscale value.

As also shown in FIG. 1A, the left image 170 and the right image 172 are based on a 2D image 115 of the object 174. In some implementations and as shown in FIG. 1A, the 2D image 115 is part of an image library 117 from which the user may select using, e.g., hand gestures. In some implementations, the left image 170 is the 2D image 115 and the right image 172 is derived using an algorithm as described with regard to FIG. 1B. In some implementations, the right image 172 is the 2D image 115 and the left image 170 is derived using the algorithm as described with regard to FIG. 1B. In some implementations, both the left image 170 and the right image 172 are derived from the algorithm as described with regard to FIG. 1B, where the displacement of the object 174 in the images 170 and 172 are symmetric with respect to the placement of the object 174 in the 2D image 115.

FIG. 1B is a diagram illustrating an example client device 130 (e.g., client device 110) on which a user views a 3D image 136 and example server device 150 configured to generate a right image 134 from a left image 132. As shown in FIG. 1B, the right image 134 is not generated on the client device 130 but rather is generated on the server device 150 remote from the client device 130, over a network 140. In some implementations, however, the right image 134 is sent to the server device 150 and the server device 150 generates the left image 132. In some implementations, a 2D image from an image library (e.g., 2D image 115) is sent to the server device 150, which in turn generates both the left image 132 and right image 134.

As shown in FIG. 1B, however, the client device 130 sends the left image 132 to the server device 150 over the network 140. For example, the network 140 can be, or can include, a local area network (LAN), a wide area network (WAN), and/or so forth. The network 140 can be, or can include, a wireless network and/or wireless network implemented using, for example, gateway devices, bridges, switches, and/or so forth. The network 140 can include one or more segments and/or can have portions based on various protocols such as Internet Protocol (IP) and/or a proprietary protocol. The network 140 can include at least a portion of the Internet. Nevertheless, in some implementations, the client device 130 is directly connected to the server device 150 without using a network such as network 140.

The server device 150, as shown in FIG. 1B, is configured to receive the left image 132 over the network 140. The server device 150 includes a processor 120 which is configured to execute an algorithm 164 for generating the right image 134 from the left image 132. In some implementations, the processor 120 is configured to execute an algorithm for generating the left image 132 from the right image 134. In some implementations, the processor 120 is configured to execute an algorithm for generating the left image 132 and the right image 134 from a 2D image. More generally, the left image 132 and the right image 134 can be referred to as a first image and a second image. As shown in FIG. 1B, the algorithm 164 includes, in order, depth model 152, depth postprocessing 154, reprojection 158, and inpainting model 160.

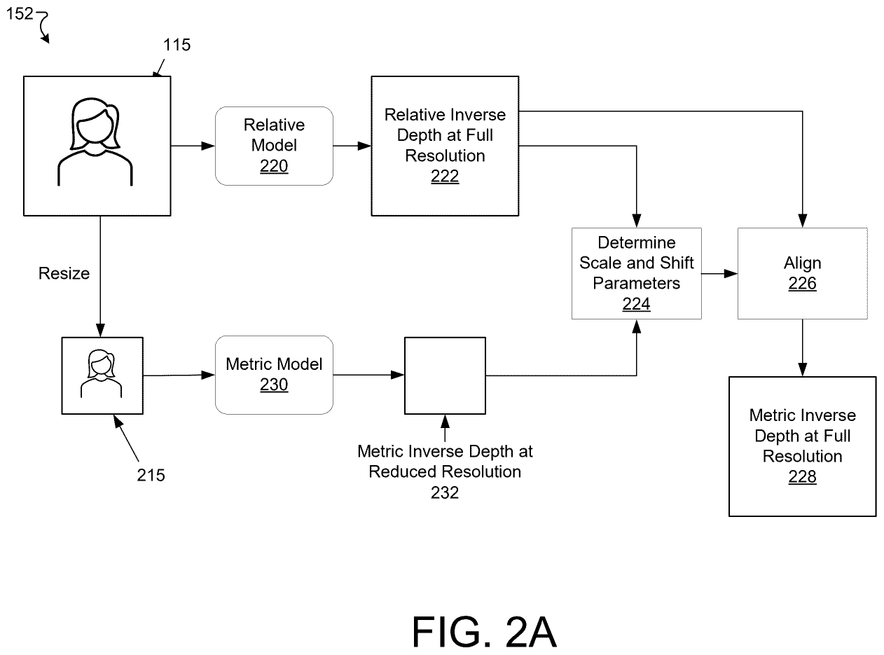

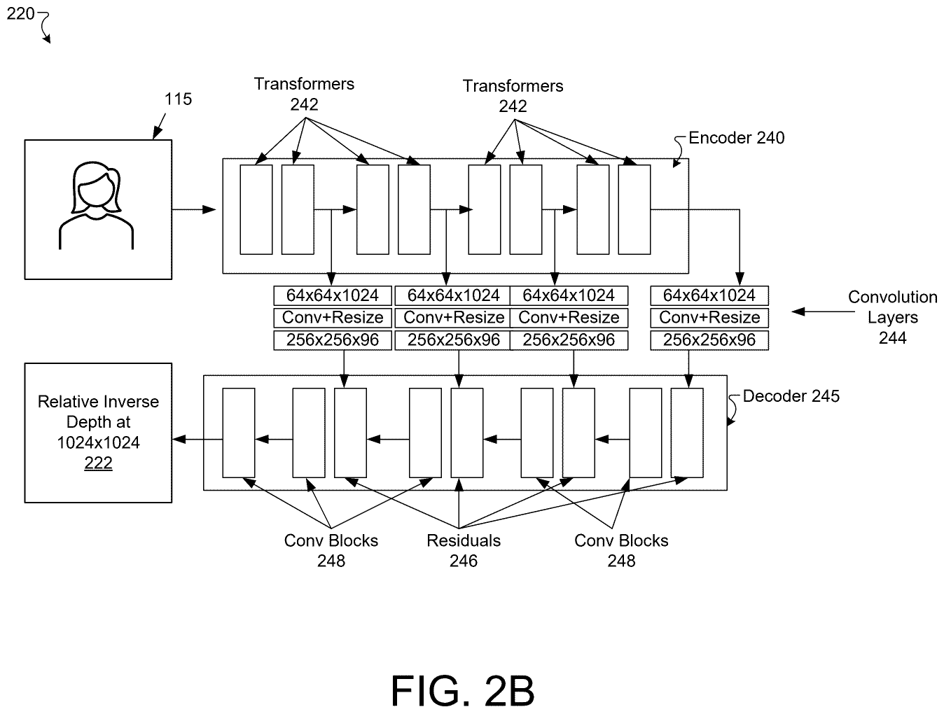

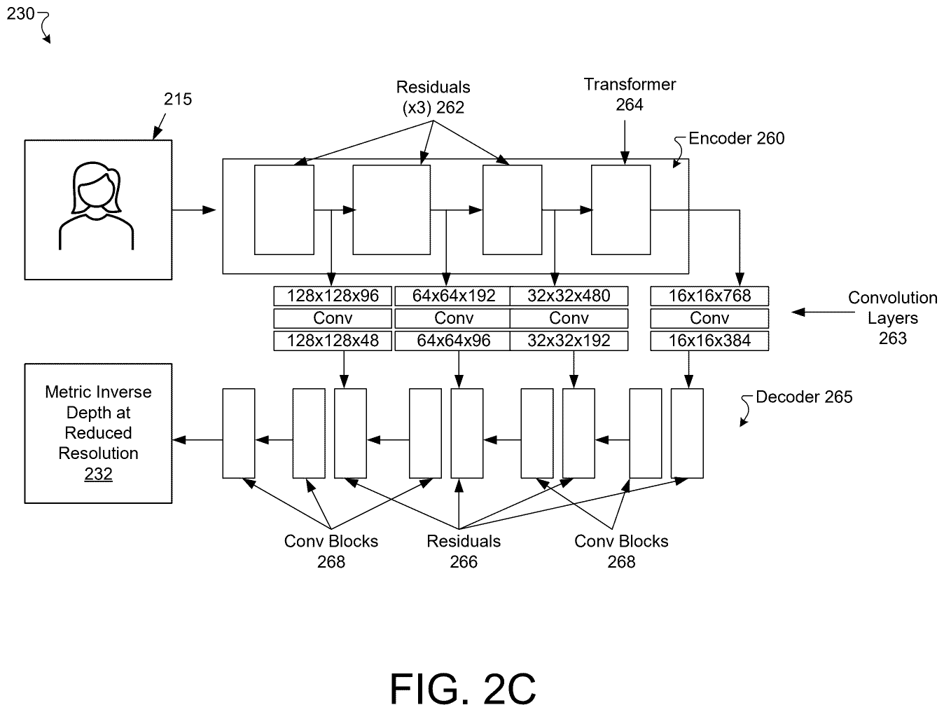

The depth model 152 is configured to generate a depth image from the left image 132. A depth image includes a plurality of pixels corresponding to a plurality of pixels of the left image 132, such that the plurality of pixels of the depth image have depth values indicating a distance from a camera that captured the left image 132. The depth model 152 uses a pair of models: a relative model configured to generate a relative inverse depth image, and a metric model configured to generate a reduced metric inverse depth image. The depth model 152 then combines the relative inverse depth image and the reduced metric inverse depth image to form, as the depth image, a metric inverse depth image. Further details of the depth model 152 are described with regard to FIGS. 2A, 2B, and 2C.

The depth postprocessing 154 is configured to address problems that may occur during the depth model 152 in the vicinity of an edge of a representation of the object (e.g., object 174). For example, the models used in the depth model 152 can predict a gradient region around an edge of the representation of the object. Such a gradient region can cause problems during the reprojection 158, e.g., the representation of the object in a foreground can be reprojected to a background, which can lead to ghosting artifacts. Accordingly, the depth postprocessing 154 includes performing an edge detection operation to determine a representation of an edge (or boundary/outline) of the object in the left image 132. The depth postprocessing 154 then includes aligning pixels of the depth image with the representation of the edge of the object. In some implementations, the depth postprocessing 154 also includes computing a horizontal min/max filter that maps each pixel of the depth image to its neighboring minimum or maximum value.

The reprojection 158 is configured to map a first pixel of the left image 132 to a second pixel of the left image 132. The mapping is based on the depth value of a pixel of the depth image corresponding to the first pixel of the left image 132. For example, when the depth value is zero or near zero, the second pixel (e.g., RGB color weights) is the same as the first pixel, i.e., no mapping occurs. In general, however, the distance to the second pixel from the first pixel increases with increasing depth value. Nominally, the mapping of the first pixel to the second pixel involves copying the RGB color weights from the first pixel to the second pixel. Nevertheless, the location of the second pixel is rounded from a floating point value (e.g., that which is based on the depth value); this then can leave holes due to the rounding.

One approach to circumvent the rounding effects involves performing a linear interpolation. That is, a weighted average of the color values of neighboring pixels are computed using weights inferred from the floating point value. Another approach involves, rather than directly mapping the pixels of the color image, mapping a pixel of the depth image corresponding to the first pixel to another pixel of the depth image corresponding to the second pixel. To address the rounding in this map, a median filter is applied to the position of the other pixel of the depth map. This produces a reprojected depth map, and the reprojected depth map is then used to determine the mapping of the left image 132 to the reprojected image.

Because of the mapping, there will be gaps in the pixels that were mapped. The pixels for which there is no content (e.g., no RGB color weights) form a mask. In some implementations, the mask, e.g., pixels that were mapped and have gaps, are associated with the representation of the edge of the object. For example, the mask is adjacent to the representation of the edge of the object.

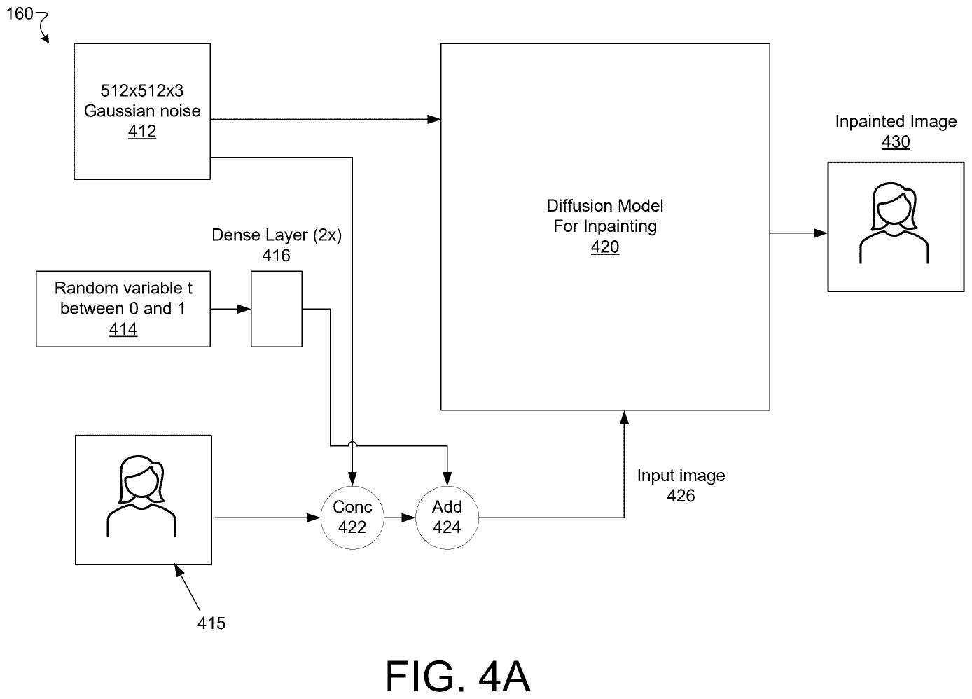

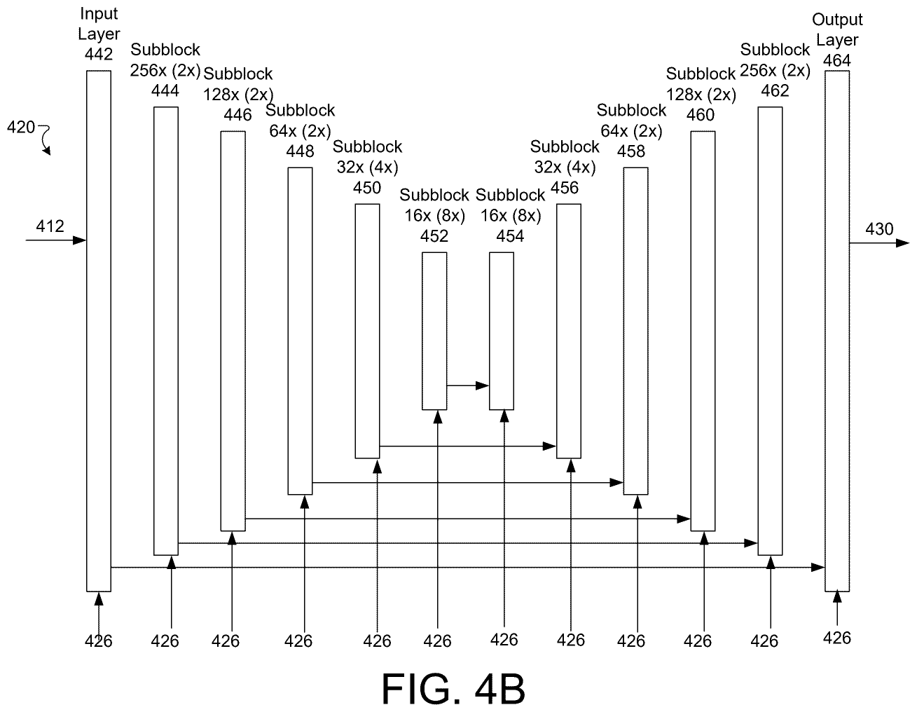

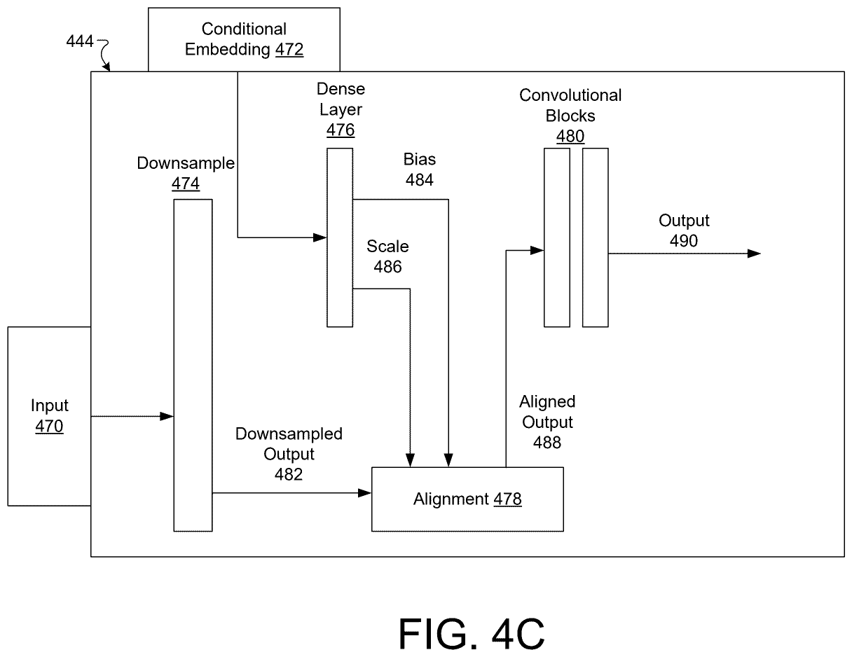

The inpainting model 160 is configured to perform an inpainting operation on the reprojected image to fill in the gaps defined by the mask, e.g., with content consistent with content of pixels outside of the mask. “Consistent” in this context means, in some implementations, that a gradient of the pixel content in the mask is about the same as the gradient of the pixel content outside of the mask. The inpainted image is the right image 134. The inpainting model 160 uses a model that includes a convolutional model arranged in a U-Net architecture. The convolutional model is, in some implementations, trained using a ground truth reprojected image captured with a camera. In some implementations, the convolutional model is trained by generating pseudo-ground-truth images from original 2D images. In some implementations, the model further includes a knowledge distillation model configured to reduce latency in generating the right image 134. Further details of the inpainting model 160 are discussed with regard to FIGS. 4A, 4B, and 4C.

FIG. 1C is a diagram illustrating the client device 130 and the server device 150 configured to generate a sequence of right frames 144 from a sequence of left frames 142. As shown in FIG. 1B, the right frames 144 are not generated on the client device 130 but rather is generated on the server device 150 remote from the client device 130, over the network 140. In some implementations, however, the right frames 144 are sent to the server device 150 and the server device 150 generates the left frames 142. In some implementations, a 2D video (sequence of frames) from a video library is sent to the server device 150, which in turn generates both the left frames 142 and right frames 144. In all cases, the sequence of left frames 142 and the sequence of right frames 144 are combined at the client device to produce 3D video 146.

As shown in FIG. 1C, however, the client device 130 sends the left frames 142 to the server device 150 over the network 140. For example, the network 140 can be, or can include, a local area network (LAN), a wide area network (WAN), and/or so forth. The network 140 can be, or can include, a wireless network and/or wireless network implemented using, for example, gateway devices, bridges, switches, and/or so forth. The network 140 can include one or more segments and/or can have portions based on various protocols such as Internet Protocol (IP) and/or a proprietary protocol. The network 140 can include at least a portion of the Internet. Nevertheless, in some implementations, the client device 130 is directly connected to the server device 150 without using a network such as network 140.

The server device 150, as shown in FIG. 1C, is configured to receive the left frames 142 over the network 140. The server device 150 includes a processor 120 which is configured to execute an algorithm 164 for generating the right frames 144 from the left frames 142. In some implementations, the processor 120 is configured to execute an algorithm for generating the left frames 142 from the right frames 144. In some implementations, the processor 120 is configured to execute an algorithm for generating the left frames 142 and the right frames 144 from a 2D video. More generally, the left frames 142 and the right frames 144 can be referred to as a first sequence of frames and a second sequence of frames. As shown in FIG. 1C, the algorithm 166 includes, in order, depth model 152(1 . . . . N), depth postprocessing 154(1 . . . . N), temporal depth processing 156(1, . . . . N), reprojection 158(1, . . . . N), inpainting model 160(1, . . . . N), and temporal inpainting 162(1, . . . . N).

The depth model, e.g., 152(1) is configured to generate a depth frame of a sequence of depth frames from a left frame 142. A depth frame includes a plurality of pixels corresponding to a plurality of pixels of the left frame 142, such that the plurality of pixels of the depth frame have depth values indicating a distance from a camera that captured the left frame 142. The depth model 152(1) uses a pair of models: a relative model configured to generate a relative inverse depth image, and a metric model configured to generate a reduced metric inverse depth image. The depth model 152(1) then combines the relative inverse depth image and the reduced metric inverse depth image to form, as the depth image, a metric inverse depth image. Further details of the depth imaging 152(1) are described with regard to FIGS. 2A, 2B, and 2C.

The depth postprocessing, e.g., 154(1) is configured to address problems that may occur during the depth model 152(1) in the vicinity of an edge of a representation of the object (e.g., object 174). For example, the models used in the depth model 152(1) can predict a gradient region around an edge of the representation of the object. Such a gradient region can cause problems during the reprojection, e.g., 158(1), e.g., the representation of the object in a foreground can be reprojected to a background, which can lead to ghosting artifacts. Accordingly, the depth postprocessing 154(1) includes performing an edge detection operation to determine a representation of an edge (or boundary) of the object in the left frame 142. The depth postprocessing 154(1) then includes aligning pixels of the depth image with the representation of the edge of the object. In some implementations, the depth postprocessing 154(1) also includes computing a horizontal min/max filter that maps each pixel of the depth image to its neighboring minimum or maximum value.

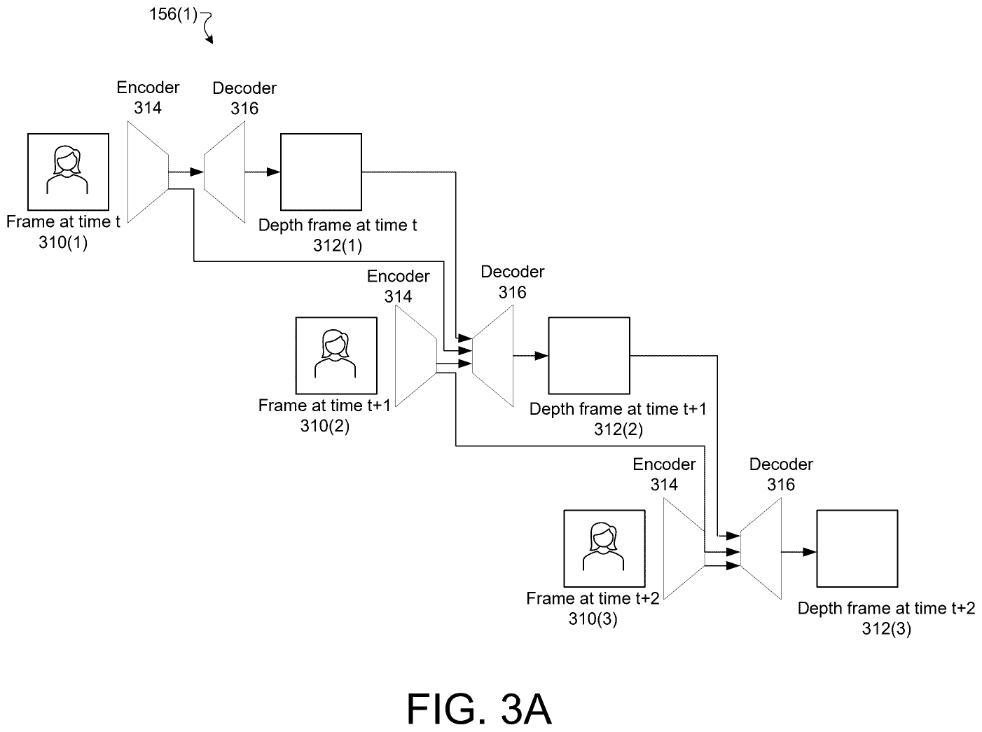

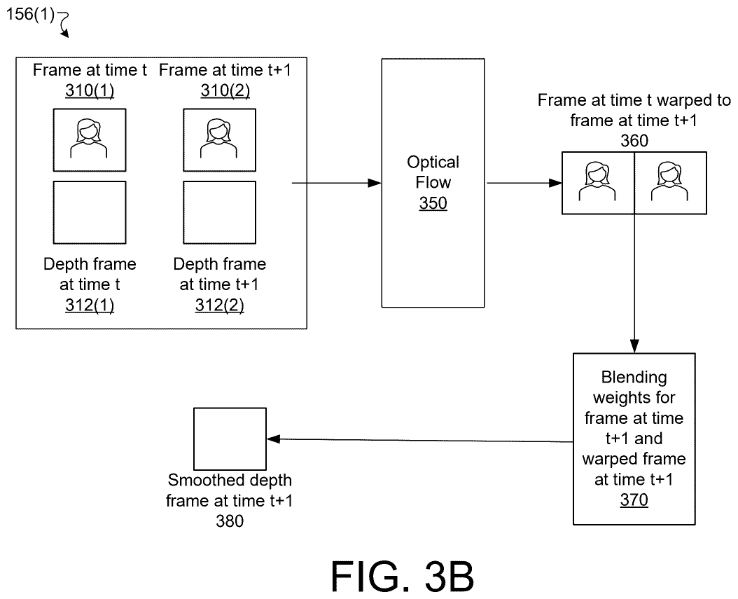

The temporal depth 156(1) is configured to provide a temporal consistency to the depth frames. A temporally consistent depth frame is generated at a time t+1 by inputting the 2D image and the depth frame at time t into the pair of depth models by which the depth frame at time t+1 is computed. Specifically, each of the pair of models has an encoder and a decoder and the encoder at time t can provide input into both the decoder at time t and the decoder at time t+1. Moreover, the depth frame generated at time t may be input into the decoder at time t+1. The temporal depth is discussed in further detail with regard to FIGS. 3A and 3B.

The reprojection, e.g., 158(1) is configured to map a first pixel of the left frame 142 to a second pixel of the left frame 142. The mapping is based on the depth value of a pixel of the depth image corresponding to the first pixel of the left frame 142. For example, when the depth value is at infinity or near infinity, the second pixel (e.g., RGB color weights) is the same as the first pixel, i.e., no mapping occurs. In general, however, the distance to the second pixel from the first pixel decreases with increasing depth value. Nominally, the mapping of the first pixel to the second pixel involves copying the RGB color weights from the first pixel to the second pixel. Nevertheless, the location of the second pixel is rounded from a floating point value (e.g., that which is based on the depth value); this then can leave holes due to the rounding.

One approach to circumvent the rounding effects involves performing a linear interpolation. That is, a weighted average of the color values of neighboring pixels are computed using weights inferred from the floating point value. Another approach involves, rather than directly mapping the pixels of the color image, mapping a pixel of the depth image corresponding to the first pixel to another pixel of the depth image corresponding to the second pixel. To address the rounding in this map, a median filter is applied to the position of the other pixel of the depth map. This produces a reprojected depth map, and the reprojected depth map is then used to determine the mapping of the left frame 142 to the reprojected image.

Because of the mapping, there will be gaps in the pixels that were mapped. The pixels for which there is no content (e.g., no RGB color weights) form a mask. In some implementations, the mask, e.g., pixels that were mapped and have gaps, are associated with the representation of the edge of the object. For example, the mask is adjacent to the representation of the edge of the object.

The inpainting model, e.g., 160(1) is configured to perform an inpainting operation on the reprojected image to fill in the gaps defined by the mask, e.g., with content consistent with content of pixels outside of the mask. “Consistent” in this context means, in some implementations, that a gradient of the pixel content in the mask is about the same as the gradient of the pixel content outside of the mask. The inpainted frame is the right frame 144. The inpainting model 160(1) uses a model that includes a convolutional model arranged in a U-Net architecture. The convolutional model is, in some implementations, trained using a ground truth reprojected image captured with a camera. In some implementations, the model further includes a knowledge distillation model configured to reduce latency in generating the right frame 144. Further details of the inpainting model 160 are discussed with regard to FIGS. 4A, 4B, and 4C.

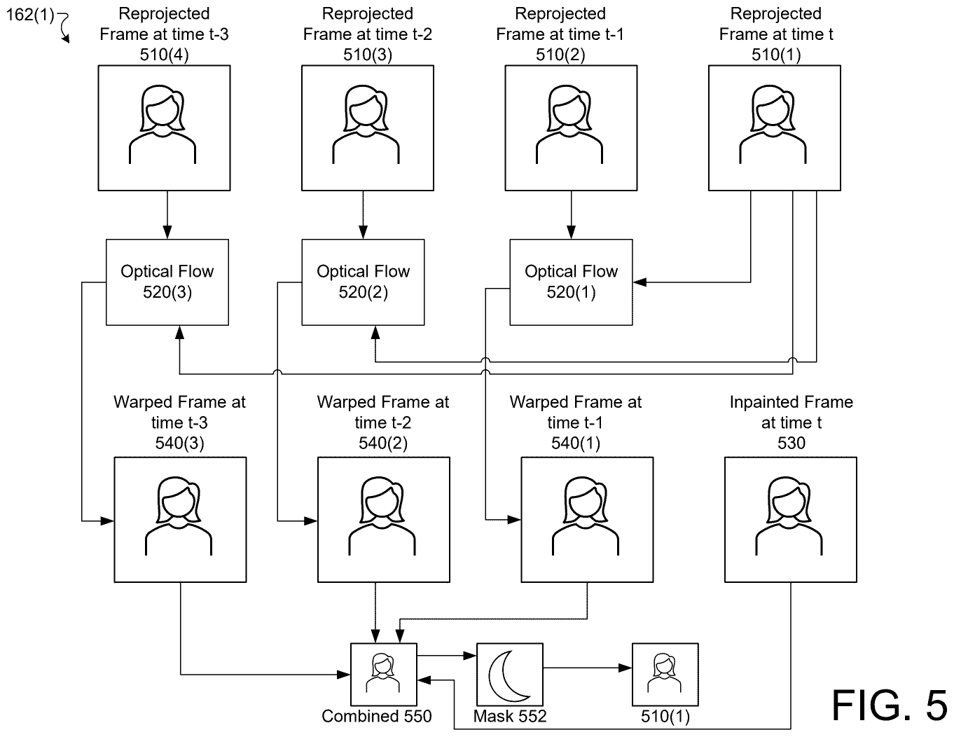

The temporal inpainting, e.g., 162(1) is configured to provide a temporal consistency to the inpainted frames. A temporally consistent inpainted frame is generated at a time t based on a set of previous reprojected frames. The temporal inpainting 160(1) computes optical flows between a reprojected frame at time t and each of a set of previous reprojected frames. For example, the optical flows may be computed for previous frames at times t−1, t−2, and t−3, although frames further back in time may also be used. The optical flows are respectively used to generate a set of warped reprojected frames at, e.g., times t−1, t−2, and t−3. The set of warped reprojected frames and the inpainted frame at time t are combined, e.g., averaged, to produce an averaged frame. The averaged frame is combined with the mask and the reprojected frame at time t to form a temporally consistent inpainted frame at time t. Further details about the temporal inpainting 162(1) are further described with regard to FIG. 5.

FIG. 2A is a diagram illustrating an example depth model 152 configured to generate a depth image 228 including a relative model 220 and a metric model 230. The depth model 152 takes as input a 2D image 115 (or frame) at full resolution, e.g., 1024×1024 pixels. This 2D image 115 is input into the relative model 220, which outputs a relative inverse depth image 222 at full resolution; the relative inverse depth image 222 includes relative values (e.g., between 0 and 1) of depth. In some implementations, the relative model 220 outputs a more general function of the relative depth, e.g., inverse squared depth. The depth model 152, in some implementations in parallel, performs a resizing of the 2D image 115 to produce a resized image 215 at, e.g., 512×512 pixels. The resized image 215 is input into the metric model 230 to produce a metric inverse depth image 232 at a reduced resolution, e.g., 512×512 pixels; the metric inverse depth image 232 includes metric depth values, e.g., distances from a camera. In some implementations, the metric model 230 outputs a more general function of the metric depth, e.g., inverse squared depth.

The depth model 152 then inputs the relative inverse depth image 222 and the metric inverse depth image 232 into a module 224 configured to determine a scale parameter value (α) and shift parameter value (β) for aligning the relative inverse depth image 222 and the metric inverse depth image 232. Aligning the relative inverse depth image 222 and the metric inverse depth image 232, or aligning their pixels, means scaling and shifting the pixels of one of the images to match the locations of the pixels of the other image. The scale parameter value is a factor by which the relative inverse depth image is multiplied, and the shift parameter value is a factor by which the relative inverse depth image is added. That is, if relative depth from the relative inverse depth image 222 is denoted as x, and metric depth from the metric inverse depth image 232 is denoted as y, then the module 224 finds the best fit (values) for a scale parameter α and a shift parameter β such that y=α*x+β. In some implementations, the module 224 finds the best fit using a least squares regression, e.g. using gradient descent or a closed form solution to find the α and β that minimize the sum over all pixels of the metric inverse depth image 232 of (α*x+β−y)². It is noted that for the case of a sequence of images for video, the least squares regression is performed for each image independently.

The scale and shift parameter values α and β determined by module 224 are input into align module 226 along with the relative inverse depth image 222. The align module 226 computes the metric inverse depth image 228 at full resolution from the equation y=α*x+β. The metric inverse depth image 228 is the depth image sought.

FIG. 2B is a diagram illustrating an example relative model 220 configured to generate a relative inverse depth image 222 at full resolution. As shown in FIG. 2B, the relative model includes an encoder 240, convolution layers 244, and a decoder 245.

As shown in FIG. 2B, the encoder 240 includes four pairs of transformers 242, or vision transformers and is configured to transform a portion (patch) of the 2D image 115 into a token, e.g., an embedding for the 2D image 115. The transformers 242 are used in place of convolutional neural networks and include alternating layers of multiheaded self-attention layers and multi-layer perceptron (MLP) blocks. Each ‘head’ relationships between pixels but focuses on a different relationship aspect. The input image 115 is broken up into patches and input into the decoder 245. After each pair of transformers 242, the output of the pair of transformers 242 is input into both the next pair of transformers 242 as well as a respective convolution layers 244. In some implementations, e.g., for the case of video, the encoder 240 includes at least one hybrid vision transformer, e.g., at least one convolution block followed by multiple transformer blocks. It is noted that a convolution block is a set of convolution layers along with any other layers, e.g., pooling layers.

As shown in FIG. 2B, the convolution layers 244 include four such layers, although four is used as an example and any other number of layers may be used. In each layer, there is a convolution layer followed by a convolution and resize operator which outputs another convolution layer. In some implementations, a 64×64×1024 convolution layer is followed by a convolution and resize operator which outputs a 256×256×96 convolution layer. The 64×64×1024 convolution layer refers to a set of 1024 feature maps at 64×64 resolution, and the 256×256×96 convolution layer refers to a set of 96 feature maps at 256×256 resolution. For the 64×64×1024 layer out of the transformer 264, 16×16 patches are extracted from the input image 115. It is noted that the sizes and numbers of feature maps stated above are not intended to be limiting and any size and number of feature maps may be used. The feature maps going out of the transformers 242 are resized to have pyramidal feature extraction and projected to a fixed size (depending on the layer). There is then a convolution operation to obtain 256 channels and then a residual 246.

As shown in FIG. 2B, the decoder 245 includes four convolution block 248—residual 246 pairs and a final convolution block 248. The decoder 245 is configured to derive a part of the output relative inverse depth image 222 based on the token derived by the encoder 240. The convolution block 248—residual 246 pairs take as input at the residuals 246 the output from the 256×256×96 convolution block in the convolution layers 244. The residuals 246 are used for combining features from two different network branches. The final convolution block 248 forms the output relative inverse depth image 222 at full resolution, e.g., 1024×1024 pixels. It is noted, however, that the number of blocks, the resolutions, and the number of feature maps shown in FIG. 2B are examples and are not intended to be limiting; any number of blocks, any resolution, and any number of feature maps may be used.

FIG. 2C is a diagram illustrating an example metric model 230 configured to generate a metric inverse depth image 232 at reduced resolution. As shown in FIG. 2C, the metric model 230 includes an encoder 260, convolution layers 263, and a decoder 265.

As shown in FIG. 2C, the encoder 260 includes three triplets of residual blocks 262 and a transformer 264 and is configured to transform a portion (patch) of the resized image 215 into a token, e.g., an embedding for the resized image 215; nevertheless, any number of residual blocks and transformers may be used. The residual blocks 262 are used for combining features from two different network branches. The transformer 264 is used in place of convolutional neural networks and includes alternating layers of multiheaded self-attention layers and multi-layer perceptron (MLP) blocks. After each residual block 262, the output of the residual block 262 is input into both the next residual block 262 or transformer 264 as well as a respective convolution layer 263.

As shown in FIG. 2C, the convolution layers 263 include four such layers. As shown in FIG. 2C, the initial layers of the convolution layers include 96 feature maps. The 64×64×1024 convolution layer refers to a set of 1024 feature maps at 64×64 resolution, and the 256×256×96 convolution layer refers to a set of 96 feature maps at 128×128 resolution, a set of 192 feature maps at 64×64 resolution, 480 feature maps at 32×32 resolution, and 768 feature maps at 16×16 resolution. It is noted, however, that the above numbers are an example and are not meant to be limiting; any resolution and number of feature maps may be used at any layer. There is a convolution operation which is then followed by convolution layers having the same resolutions but with 48, 96, 192, and 384 feature maps respectively. For the 64×64×1024 layer out of the transformer 264, 16×16 patches are extracted from the image 215. It is noted, however, that the above numbers are an example and are not meant to be limiting; any resolution and number of feature maps may be used at any layer.

The decoder 265 includes four convolution blocks 248—residual 246 pairs and a final convolution block 248. The decoder 265 is configured to derive a portion of the output metric inverse depth image 232 from the token derived by the encoder 260. The convolution block 268—residual 266 pairs take as input at the residuals 266 the output from the convolution layers 244. The final convolution block 268 forms the output metric inverse depth image 232 at reduced resolution, e.g., 512×512 pixels.

FIG. 3A is a diagram illustrating an example model 156(1) configured to generate temporally consistent depth frames 312(1), 312(2), 312(3) in the case of multiple frames, e.g., 310(1), 310(2), 310(3). In some implementations, the multiple frames 310(1), 310(2), 310(3) form a sequence. In some implementations, the multiple frames 310(1), 310(2), 310(3) do not form a sequence. The model 156(1) includes an encoder 314 and a decoder 316. In some implementations, the encoder 314 is encoder 240 (FIG. 2B) and the decoder 316 is decoder 265 (FIG. 2C).

According to model 156(1), the frame 310(1) at time t is input into the encoder 314. The output of the encoder 314 at time t is input into the decoder 316 at both time t and time t+1. The output of the decoder 316 at time t, the depth frame 312(1) at time t, is also input into the decoder 316 at time t+1. Moreover, the image frame 310(2) at time t+1 is input into the encoder 314, and the output of the encoder 314 at time t+1 is input into the decoder 316 at time t+1 as well as decoder 316 at time t+2. The output of the decoder 316 at time t+1 is the temporally consistent depth frame 312(2) at time t+1.

The above process may be continued across all frames. For example, as shown in FIG. 2A, the frame 310(3) is input into the encoder 314 at time t+2, the output of which is input into the decoder 316 at time t+2. The temporally consistent depth frame 312(2) at time t+1 is input into the decoder 316 at time t+2. The output of the decoder 316 at time t+2 is then the temporally consistent depth frame 312(3) at time t+2. Repeating this process will result in temporally consistent depth frames.

FIG. 3B is a diagram illustrating an example model 156(1) configured to generate temporally consistent depth frames in the case of a sequence of multiple frames 310(1), 310(2), etc.

The model 156(1) takes as input image frames 310(1) and 310(2) at times t and t+1, respectively, as well as corresponding depth frames 312(1) and 312(2) at times t and t+1, respectively. The model, from the images frames 310(1), 310(2) and depth frames 312(1), 312(2), computes an optical flow 350 representing an apparent motion of pixels between image frames 310(1) and 310(2). The optical flow 350, applied to image frames 310(1) and 310(2), produces a warped frame 360, that is, an image frame at time t warped to an image frame at time t+1. Using the warped frame 360 and the image frame 310(2) at time t+1, the model 156(1) generates blending weights 370 for the image frame 310(2) at time t+1 and the warped frame 360 at time t+1. The blending weights 370 are then applied to the depth frames 312(2) at time t+1 to produce a smoothed depth frame 380 at time t+1.

FIG. 4A is a diagram illustrating an example model 160 configured to generate an inpainted image 430 from a reprojected image 415. As shown in FIG. 4A, the model 160 includes a pair of dense layers 416, a concatenator 422, an adder 424, and a diffusion model 420.

Input into the model 160 are a reprojected image 415 at a reduced resolution, e.g., 512×512. Also input into the model 160 are a color Gaussian noise image 412, e.g., of resolution 512×512 and a random variable t 414 between 0 and 1. The Gaussian noise image 412 is directly input into the diffusion model 420. The random variable t 414 is input into the dense layers 416. The reprojected image 415, which has a mask associated with a representation of an edge of an object, is concatenated with the Gaussian noise image 412 and the result is added to the output of the dense layers 416 to form an input image 426. The input image 426 is then input into the diffusion model 420 along with the Gaussian noise image 412. The diffusion model, from those inputs, outputs an inpainted image 430.

FIG. 4B is a diagram illustrating the diffusion model 420 that is part of the inpainting model 160. As shown in FIG. 4B, the diffusion model 420 is a U-net convolutional model. The U-net convolutional model has an input layer 442 of resolution 512×512 with 128 feature maps, an output layer 464 of resolution 512×512 with 128 feature maps, and various subblocks in between. The input layer 442 has a connection with the output layer 464.

The Gaussian noise image 412 and the input image 426 are input into the input layer 442; the output of this is input into the pair of subblocks 444 having a resolution of 256×256 with 128 feature maps; these subblocks are linked to the pair of subblocks 462 of the same resolution and number of feature maps.

Next is a pair of subblocks 446 having a resolution of 128×128 with 128 feature maps; these subblocks are linked to the pair of subblocks 460 of the same resolution and number of feature maps.

Next is a pair of subblocks 448 having a resolution of 64×64 with 256 feature maps; these subblocks are linked to the pair of subblocks 458 of the same resolution and number of feature maps.

Next is a quadruplet of subblocks 450 having a resolution of 32×32 with 512 feature maps; these subblocks are linked to the pair of subblocks 456 of the same resolution and number of feature maps.

Next is an octuplet of subblocks 452 having a resolution of 16×16 with 1024 feature maps; these subblocks are linked to the pair of subblocks 454 of the same resolution and number of feature maps.

The output of the output layer 464 is the inpainted image 430.

The training of the diffusion model 420 can use an Open Images dataset with custom masks. The image resolution during training can be 512×512.

FIG. 4C is a diagram illustrating an example subblock 444 of the diffusion model 420. As shown in FIG. 4C, the subblock 444 includes a downsample block 474, a dense layer 476, an alignment block 478, and a pair of convolutional blocks 480.

The subblock 444 has an input 470 which may correspond to output from a previous block, e.g., input layer 442. The input 470 is input into the downsample block 474 to produce as output a downsampled output 482. For example, a 512×512 resolution of input 470 can become a 256×256 resolution of the downsampled output 482. The downsampled output 482 is then input into the alignment block 478.

The subblock 444 also has a conditional embedding 472 that is input into the dense layer 476. The output of the dense layer 476 is a bias 484 and a scale 486; the bias 484 and scale 486 are also input into the alignment block 478. If the downsampled output 482 is denoted as x, then the aligned output 488 produced by the alignment block 478 is given by (1+scale)*x+bias.

The aligned output 488 is input into the pair of convolutional blocks 480. The output of the pair of convolutional blocks 480 is the output 490 of the subblock 444. The output 490 is then input into the next subblock 446 as well as the subblock 462.

FIG. 5 is a diagram illustrating an example model 162(1) for generating a temporally consistent inpainting of reprojected frames 510(1 . . . 4) in the case of a sequence of multiple frames. As shown in FIG. 5, the model 162(1) takes as input reprojected frames 510(1), 510(2), 510(3), 510(4) at times t, t−1, t−2, and t−3, respectively. This example, however, should not be seen as limiting and any number of previous reprojected frames may be used.

The model 162(1) computes an optical flow 520(1) between the reprojected frame 510(1) at time t and the reprojected frame 510(2) at time t−1. The model 162(1) computes an optical flow 520(2) between the reprojected frame 510(1) at time t and the reprojected frame 510(3) at time t−2. The model 162(1) computes an optical flow 520(3) between the reprojected frame 510(1) at time t and the reprojected frame 510(4) at time t−3.

The model 162(1) uses the optical flow 520(1) to generate a warped reprojected frame 540(1) at time t−1. The warped reprojected frame 540(1) represents a difference in content of the pixels between time t−1 and time t, or in other words, a frame in which the apparent motion of pixels is applied. The model 162(1) uses the optical flow 520(2) to generate a warped reprojected frame 540(2) at time t−2. The model 162(1) uses the optical flow 520(3) to generate a warped reprojected frame 540(3) at time t−3.

The model 162(1) then combines the warped reprojected frames 540(1), 540(2), 540(3), and the inpainted frame 530 at time t to produce a combined frame 550. For example, the warped reprojected frames 540(1), 540(2), 540(3), and the inpainted frame 530 may be averaged. The combined frame 550 is then multiplied by the mask 552 of the reprojected frame 510(1) at time t, and the result added to the reprojected frame 510(1) at time t, to form a temporally consistent inpainted frame at time t.

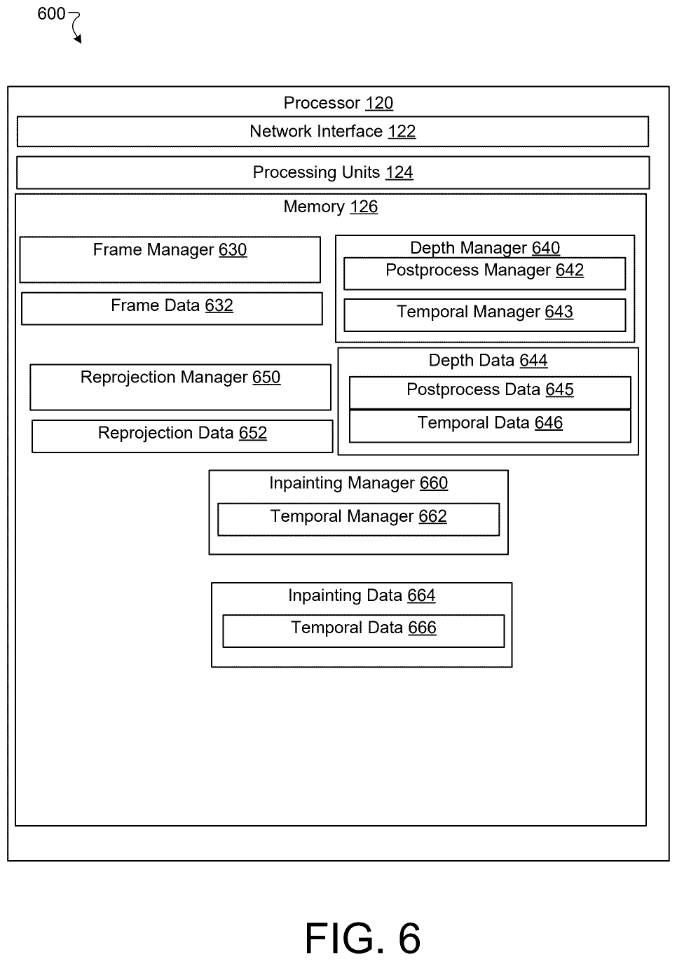

FIG. 6 is a diagram illustrating an example electronic environment 600 in which the derivation of a right image or frame from a left image or frame may be performed. As shown in FIG. 6, the electronic environment includes the processor 120 of the server device 150 of FIGS. 1B and 1C.

The processor 120 includes a network interface 122, one or more processing units 124, and the (nontransitory) memory 126. The network interface 122 includes, for example, Ethernet adaptors, Bluetooth adaptors, and the like, for converting electronic and/or optical signals received from the network to electronic form for use by the processor 120. The set of processing units 124 include one or more processing chips and/or assemblies. The memory 126 is a storage medium and includes both volatile memory (e.g., RAM) and non-volatile memory, such as one or more read only memories (ROMs), disk drives, solid state drives, and the like. The set of processing units 124 and the memory 126 together form part of the processor 120, which is configured to perform various methods and functions as described herein as a computer program product.

In some implementations, one or more of the components of the processor 120 can be, or can include processors (e.g., processing units 124) configured to process instructions stored in the memory 126. Examples of such instructions as depicted in FIG. 6 include a frame manager 630, a depth manager 640, a reprojection manager 650, and an inpainting manager 660. Further, as illustrated in FIG. 6, the memory 126 is configured to store various data, which is described with respect to the respective managers that use such data.

The frame manager 630 is configured to receive image frames (frame data 632) from a client device (e.g., client device 130 of FIGS. 1B and 1C). The frame manager 630 may, for example, receive the frame data 632 over a network such as network 140 via network interface 122. In some implementations, the frame manager 630 is configured to receive the frame data 632 directly, e.g., without a network, from the client device. In some implementations, the frame data represents left frames. In some implementations, the frame data 632 represents right frames. In some implementations, the frame data 632 represents center data.

The depth manager 640 is configured to generate depth frames (depth data 644) from the frame data 632. For example, the depth manager 640 is configured to use a pair of models: a relative model configured to generate a relative inverse depth image, and a metric model configured to generate a reduced metric inverse depth image. The depth manager 640 is then configured to combine the relative inverse depth image and the reduced metric inverse depth image to form, as the depth image, a metric inverse depth image. As shown in FIG. 6, the depth manager 640 includes a postprocessing manager 642 and a temporal manager 643.

The postprocessing manager 642 is configured to address problems that may occur during the depth generation of depth data 644 in the vicinity of an edge of a representation of the object (e.g., object 174). For example, the models used by the depth manager 640 can predict a gradient region around an edge of the representation of the object. Such a gradient region can cause problems during the reprojection, e.g., using reprojection manager 650. Accordingly, the postprocessing manager 642 is configured to perform an edge detection operation to determine a representation of an edge (or boundary) of the object in frame data 632. The postprocessing manager 642 is then configured to align pixels of the depth image with the representation of the edge of the object and produce postprocessing data 645. In some implementations, the postprocessing manager 642 is also configured to compute a horizontal min/max filter that maps each pixel of the depth image to its neighboring minimum or maximum value.

The temporal manager 643 is configured to generate temporally consistent depth images (temporal data 646) from depth data 644. The temporal manager 643 is configured to generate a temporally consistent depth frame at a time t+1 (temporal data 646) by inputting the frame data 632 and the depth data 644 at time t into the pair of models by which the depth frame at time t+1 is computed. Specifically, each of the pair of models has an encoder and a decoder and the encoder at time t can provide input into both the decoder at time t and the decoder at time t+1. Moreover, the depth frame generated at time t may be input into the decoder at time t+1.

The reprojection manager 650 is configured to perform a reprojection operation on the depth data 644 to produce reprojection data 652. The reprojection manager 650 is configured to map a first pixel from the frame data 632 to a second pixel of the frame data 632. The mapping is based on the depth value of a pixel of depth data 644 corresponding to the first pixel of the frame data 632. For example, when the depth value is infinity or near infinity, the second pixel (e.g., RGB color weights) is the same as the first pixel, i.e., no mapping occurs. In general, however, the distance to the second pixel from the first pixel decreases with increasing depth value. Nominally, the mapping of the first pixel to the second pixel involves copying the RGB color weights from the first pixel to the second pixel. Nevertheless, the reprojection manager 650 is configured to round the location of the second pixel from a floating point value (e.g., that which is based on the depth value); this then can leave holes due to the rounding.

One approach to circumvent the rounding effects involves performing a linear interpolation. That is, a weighted average of the color values of neighboring pixels are computed using weights inferred from the floating point value. Another approach involves, rather than directly mapping the pixels of the color image, mapping a pixel of the depth image corresponding to the first pixel to another pixel of the depth image corresponding to the second pixel. To address the rounding in this map, the reprojection manager 650 is configured to apply a median filter to the position of the other pixel of the depth map. This produces a reprojected depth map, and the reprojected depth map is then used to determine the mapping of the frame data 632 to the reprojection data 652.

The inpainting manager 660 is configured to perform an inpainting operation on the reprojection data 652 to fill in the gaps defined by the mask, e.g., with content consistent with content of pixels outside of the mask, and to produce inpainting data 664. “Consistent” in this context means, in some implementations, that a gradient of the pixel content in the mask is about the same as the gradient of the pixel content outside of the mask. The inpainting data 664 represents a right frame when the frame data 632 represents a left frame. The inpainting manager 660 uses an inpainting model that includes a convolutional model arranged in a U-Net architecture. The convolutional model is, in some implementations, trained using a ground truth reprojected image captured with a camera. In some implementations, the inpainting model further includes a knowledge distillation model configured to reduce latency in generating the right frame. As shown in FIG. 6, the inpainting manager 660 includes a temporal manager 662.

The temporal manager 662 is configured to perform temporally consistent inpainting of the reprojection data 652. To do this, the temporal manager 662 is configured to compute optical flows between a reprojected frame at time t and each of a set of previous reprojected frames. For example, the optical flows may be computed for previous frames at times t−1, t−2, and t−3, although frames further back in time may also be used. The temporal manager 662 is configured to use the optical flows respectively to generate a set of warped reprojected frames at, e.g., times t−1, t−2, and t−3. The temporal manager 662 is configured to combine the set of warped reprojected frames and the inpainted frame at time t, e.g., averaged, to produce an averaged frame. The temporal manager 662 is configured to combine the averaged frame with the mask and the reprojected frame at time t to form a temporally consistent inpainted frame at time t (temporal data 666).

The components (e.g., modules, processing units 124) of processor 120 can be configured to operate based on one or more platforms (e.g., one or more similar or different platforms) that can include one or more types of hardware, software, firmware, operating systems, runtime libraries, and/or so forth. In some implementations, the components of the processor 120 can be configured to operate within a cluster of devices (e.g., a server farm). In such an implementation, the functionality and processing of the components of the processor 120 can be distributed to several devices of the cluster of devices.

The components of the processor 120 can be, or can include, any type of hardware and/or software configured to process attributes. In some implementations, one or more portions of the components shown in the components of the processor 120 in FIG. 6 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 120 can be, or can include, a software module configured for execution by at least one processor (not shown). In some implementations, the functionality of the components can be included in different modules and/or different components than those shown in FIG. 6, including combining functionality illustrated as two components into a single component. In some implementations, the models used by the depth manager 640 and the inpainting manager 660 and temporal manager 662 can be executed on any one of several types of processors, including a central processing unit (CPU), a graphics processing unit (GPU), and/or a tensor processing unit (TPU). In such implementations, the other managers would run on a CPU.

Although not shown, in some implementations, the components of the processor 120 (or portions thereof) can be configured to operate within, for example, a data center (e.g., a cloud computing environment), a computer system, one or more server/host devices, and/or so forth. In some implementations, the components of the processor 120 (or portions thereof) can be configured to operate within a network. Thus, the components of the processor 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, frame manager 630 (and/or a portion thereof), depth manager 640 (and/or a portion thereof), reprojection manager 650 (and/or a portion thereof), and inpainting manager 660 (and/or a portion thereof) are examples of such instructions.

In some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the processor 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the processor 120. As illustrated in FIG. 6, the memory 126 is configured to store various data, including frame data 632 and depth data 644.

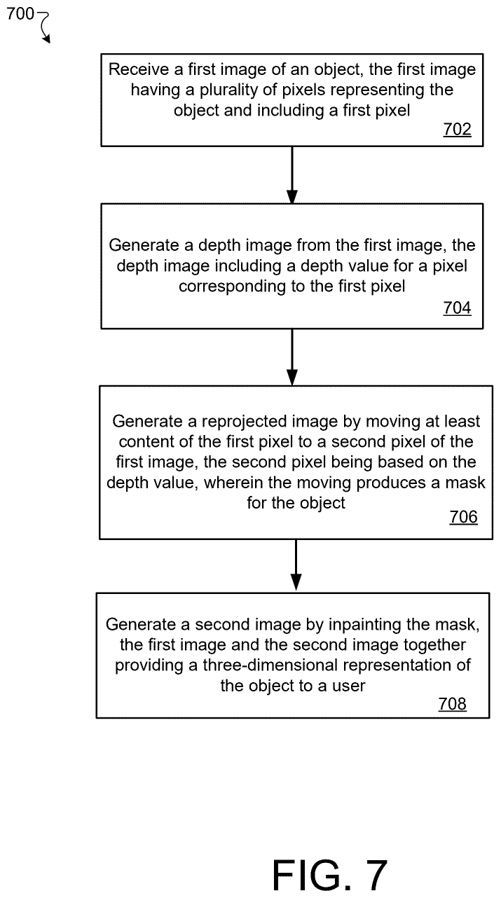

FIG. 7 is a flow chart illustrating an example process 700 of generating a 3D image. The process 700 may be carried out on a processor and memory such as processor 120 and memory 126 of FIG. 6.

At 702, a frame manager, e.g., frame manager 630 receives a first image (e.g., left image 132) of an object (e.g., object 174), the first image including a first pixel (see, e.g., image 115 at 1024×1024 pixels).

At 704, a depth manager, e.g., depth manager 640 generates a depth image (e.g., metric inverse depth image 228) from the first image, the depth image including a pixel corresponding to the first pixel of the first image and having a depth value.

At 706, a reprojection manager, e.g., reprojection manager 650 generates a reprojected image by mapping content of the first pixel to a second pixel (see, e.g., image 115 at 1024×1024 pixels) of the first image based on the depth value of the pixel of the depth image, the reprojected image having a mask (e.g., mask 552) defined by a representation of the object.

At 708, an inpainting manager, e.g., inpainting manager 660 generates a second image (e.g., right image 134) by inpainting the mask defined by the representation of the object, the first image and the second image together providing a three-dimensional representation of the object (e.g., 3D image 136) to a user.

Example 1. A method, comprising: receiving a first image of an object, the first image having a plurality of pixels representing the object and including a first pixel; generating a depth image from the first image, the depth image including a depth value for a pixel corresponding to the first pixel; generating a reprojected image by moving at least content of the first pixel to a second pixel of the first image, the second pixel being based on the depth value, wherein the moving produces a mask for the object; and generating a second image by inpainting the mask, the first image and the second image together providing a three-dimensional representation of the object to a user.

Example 2. The method as in example 1, wherein the first image and the depth image have a first resolution; and wherein generating the depth image includes: generating a resized image by resizing the first image to have a second resolution; using a first model to generate a first depth image from the first image, the first depth image representing a function of relative distance from a camera and having the first resolution; and using a second model to generate a second depth image from the resized image, the second depth image representing a function of metric distance from the camera and having the second resolution; and wherein the depth image is generated based on the first depth image and the second depth image.

Example 3. The method as in example 2, wherein generating the depth image further includes: computing, via the second model, a normalized metric distance from the camera based on a focal length of the camera; and aligning the first depth image to the second depth image using the normalized metric distance from the camera.

Example 4. The method as in example 3, wherein aligning the first depth image to the second depth image includes: determining a value of a scale parameter and a value of a shift parameter for aligning the first depth image to the second depth image based on the normalized metric distance from the camera.

Example 5. The method as in example 2, wherein the first model includes an encoder, a decoder, and a set of convolutional layers, the encoder including a plurality of transformer blocks, the decoder including a plurality of pairs of convolutional blocks and residual blocks.

Example 6. The method as in example 2, wherein the second model includes an encoder, a decoder, and a set of convolutional layers, the encoder including a plurality of residual blocks and a transformer, the decoder including a plurality of pairs of convolutional blocks and residual blocks.

Example 7. The method as in example 1, further comprising performing a postprocessing operation on the depth image by: determining a representation of an edge of the object in the first image; and aligning pixels of the depth image with the representation of the edge of the object.

Example 8. The method as in example 1, wherein the first image is an initial frame of a sequence of frames and the depth image is an initial depth frame corresponding to the initial frame; and wherein the method further comprises: receiving a next frame of the sequence of frames representing a next time step from the initial frame; and generating a next depth frame corresponding to the next frame based on the initial frame, the initial depth frame, and the next frame.

Example 9. The method as in example 8, further comprising: generating an optical flow based on the initial frame, the next frame, the initial depth frame, and the next depth frame; generating a warped next frame based on the optical flow; and combining the next frame and the warped next frame to produce a smoothed next depth frame.

Example 10. The method as in example 1, wherein mapping the content of the first pixel to the second pixel based on the depth value includes: combining color values of pixels neighboring the second pixel and the content of the first pixel.

Example 11. The method as in example 10, wherein generating the reprojected image includes: determining a representation of an edge of the object in the first image; and generating, as the mask, a set of pixels of the reprojected image adjacent to the representation of the edge of the object.

Example 12. The method as in example 1, wherein inpainting the mask defined by the representation of the object includes: using an inpainting model to generate content for pixels in the mask, the content being consistent with content of pixels outside of the mask, the inpainting model being based on the reprojected image.

Example 13. The method as in example 12, wherein the inpainting model includes a knowledge distillation model configured to reduce latency in generating the second image.

Example 14. The method as in example 12, wherein the reprojected image is a current reprojected frame of a sequence of reprojected frames; and wherein the method further comprises: receiving a set of previous reprojected frames of the sequence of reprojected frames, the set of previous reprojected frames having a set of corresponding masks; and generating the second image based on the set of previous reprojected frames and an inpainted reprojected image.

Example 15. The method as in example 15, wherein generating the second image based on the set of previous reprojected frames and the inpainted reprojected image includes: computing an optical flow between the set of previous reprojected frames and the current reprojected frame; generating a set of warped previous reprojected frames based on the optical flow; and combining the inpainted reprojected image and the set of warped previous reprojected frames to produce the second image.

Example 16. A computer program product comprising a nontransitory storage medium, the computer program product including code that, when executed by processing circuitry, causes the processing circuitry to perform a method, the method comprising: receiving a first image of an object, the first image including a first pixel; generating a depth image from the first image, the depth image including a pixel corresponding to the first pixel of the first image and having a depth value; generating a reprojected image by mapping content of the first pixel to a second pixel of the first image based on the depth value of the pixel of the depth image, the reprojected image having a mask defined by a representation of the object; and generating a second image by inpainting the mask defined by the representation of the object, the first image and the second image together providing a three-dimensional representation of the object to a user.

Example 17. The computer program product as in example 16, wherein the first image and the depth image have a first resolution; and wherein generating the depth image includes: generating a resized image by resizing the first image to have a second resolution; using a first model to generate a first depth image from the first image, the first depth image representing a function of relative distance from a camera and having the first resolution; and using a second model to generate a second depth image from the resized image, the second depth image representing a function of metric distance from the camera and having the second resolution; and wherein the depth image is generated based on the first depth image and the second depth image.

Example 18. The computer program product as in example 17, wherein generating the depth image further includes: computing, via the second model, a normalized metric distance from the camera based on a focal length of the camera; and aligning the first depth image to the second depth image using the normalized metric distance from the camera.

Example 19. An apparatus, comprising: memory; and a processor coupled to the memory, the processor being configured to: receive a first image of an object, the first image including a first pixel; generate a depth image from the first image, the depth image including a pixel corresponding to the first pixel of the first image and having a depth value; generate a reprojected image by mapping content of the first pixel to a second pixel of the first image based on the depth value of the pixel of the depth image, the reprojected image having a mask defined by a representation of the object; and generate a second image by inpainting the mask defined by the representation of the object, the first image and the second image together providing a three-dimensional representation of the object to a user.

Example 20. The apparatus as in example 19, wherein the first image and the depth image have a first resolution; and wherein the processor configured to generate the depth image is further configured to: generate a resized image by resizing the first image to have a second resolution; use a first model to generate a first depth image from the first image, the first depth image representing a function of relative distance from a camera and having the first resolution; and use a second model to generate a second depth image from the resized image, the second depth image representing a function of metric distance from the camera and having the second resolution; and wherein the depth image is generated based on the first depth image and the second depth image.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method, comprising:
receiving a first image of an object, the first image having a plurality of pixels representing the object that include a first pixel;
generating a depth image from the first image, the depth image including a depth value for a pixel corresponding to the first pixel;
generating a reprojected image by moving at least content of the first pixel to a second pixel of the first image, the second pixel being identified based on the depth value, wherein the moving produces a mask defined by the plurality of pixels; and
generating a second image by inpainting the mask, the first image and the second image together providing a three-dimensional representation of the object to a user.

2. The method as in claim 1, further comprising performing a postprocessing operation on the depth image by:
determining a representation of an edge of the object in the first image; and
aligning pixels of the depth image with the representation of the edge of the object.

3. The method as in claim 1, wherein the first image and the depth image have a first resolution; and
wherein generating the depth image includes:
generating a resized image by resizing the first image to have a second resolution;
using a first model to generate a first depth image from the first image, the first depth image representing relative distances from a camera and having the first resolution; and
using a second model to generate a second depth image from the resized image, the second depth image representing metric distances from the camera and having the second resolution; and
wherein the depth image is generated based on the first depth image and the second depth image.

4. The method as in claim 3, wherein generating the depth image further includes:
computing, via the second model, a normalized metric distance from the camera based on a focal length of the camera; and
aligning the first depth image to the second depth image using the normalized metric distance from the camera.

5. The method as in claim 4, wherein aligning the first depth image to the second depth image includes:
determining a value of a scale parameter and a value of a shift parameter; and
using the value of the scale parameter and the value of the shift parameter in aligning the first depth image to the second depth image.

6. The method as in claim 3, wherein the first model includes an encoder and a decoder, the encoder configured to transform a portion of the first image into a token, the decoder configured to derive a portion of the first depth image from the token.

7. The method as in claim 3, wherein the second model includes an encoder and a decoder, the encoder being configured to transform a portion of the resized image into a token, the decoder being configured to derive a portion of the second depth image from the token.

8. The method as in claim 1, wherein the first image is an initial frame of a sequence of frames and the depth image is an initial depth frame corresponding to the initial frame; and
wherein the method further comprises:
receiving a next frame of the sequence of frames representing a next time step from the initial frame; and
generating a next depth frame corresponding to the next frame based on the initial frame, the initial depth frame, and the next frame.

9. The method as in claim 8, further comprising:
generating an optical flow based on the initial frame, the next frame, the initial depth frame, and the next depth frame;
generating a warped next frame based on the optical flow; and
combining the next frame and the warped next frame to produce a smoothed next depth frame.

10. The method as in claim 1, wherein mapping at least the content of the first pixel to the second pixel based on the depth value includes:
combining color values of pixels neighboring the second pixel and at least the content of the first pixel.

11. The method as in claim 10, wherein generating the reprojected image includes:
determining a representation of a boundary of the object in the first image; and
generating, as the mask, a set of pixels of the reprojected image adjacent to the representation of the boundary of the object.

12. The method as in claim 1, wherein inpainting the mask includes:
using an inpainting model to generate content for pixels in the mask, the content being consistent with content of pixels outside of the mask, the inpainting model being based on the reprojected image.

13. The method as in claim 12, wherein the inpainting model includes a knowledge distillation model configured to reduce latency in generating the second image.

14. The method as in claim 12, wherein the reprojected image is a current reprojected frame of a sequence of reprojected frames; and
wherein the method further comprises:
receiving a set of previous reprojected frames of the sequence of reprojected frames, the set of previous reprojected frames having a set of corresponding masks; and
generating the second image based on the set of previous reprojected frames and an inpainted reprojected image.

15. The method as in claim 14, wherein generating the second image based on the set of previous reprojected frames and the inpainted reprojected image includes:
computing an optical flow between the set of previous reprojected frames and the current reprojected frame;
generating a set of warped previous reprojected frames based on the optical flow; and
combining the inpainted reprojected image and the set of warped previous reprojected frames to produce the second image.

16. The method as in claim 1, wherein the mask includes a set of pixels adjacent to the plurality of pixels.

17. A computer program product comprising a nontransitory storage medium, the computer program product including code that, when executed by processing circuitry, causes the processing circuitry to perform a method, the method comprising:
receiving a first image of an object, the first image having a plurality of pixels representing the object that include a first pixel;
generating a depth image from the first image, the depth image including a depth value for a pixel corresponding to the first pixel;
generating a reprojected image by moving at least content of the first pixel to a second pixel of the first image, the second pixel being identified based on the depth value wherein the moving produces a mask defined by the plurality of pixels; and
generating a second image by inpainting the mask, the first image and the second image together providing a three-dimensional representation of the object to a user.

18. The computer program product as in claim 17, wherein the first image and the depth image have a first resolution; and
wherein generating the depth image includes:
generating a resized image by resizing the first image to have a second resolution;
using a first model to generate a first depth image from the first image, the first depth image representing a function of relative distance from a camera and having the first resolution; and
using a second model to generate a second depth image from the resized image, the second depth image representing a function of metric distance from the camera and having the second resolution; and
wherein the depth image is generated based on the first depth image and the second depth image.

19. An apparatus, comprising:
memory; and
a processor coupled to the memory, the processor being configured to:
receive a first image of an object, the first image having a plurality of pixels representing the object that include a first pixel;
generate a depth image from the first image, the depth image including a depth value for a pixel corresponding to the first pixel;
generate a reprojected image by moving at least content of the first pixel to a second pixel of the first image, the second pixel being identified based on the depth value, wherein the moving produces a mask defined by the plurality of pixels; and
generate a second image by inpainting the mask, the first image and the second image together providing a three-dimensional representation of the object to a user.

20. The apparatus as in claim 19, wherein the first image and the depth image have a first resolution;
wherein the processor configured to generate the depth image is further configured to:
generate a resized image by resizing the first image to have a second resolution;
use a first model to generate a first depth image from the first image, the first depth image representing a function of relative distance from a camera and having the first resolution; and
use a second model to generate a second depth image from the resized image, the second depth image representing a function of metric distance from the camera and having the second resolution; and
wherein the depth image is generated based on the first depth image and the second depth image.
